(19) United States
(12) Patent Application Publication
(10) Pub. No.: US 2018/0219500 A1
(43) Pub. Date: Aug. 2, 2018

(54) 2-PHASE BRUSHLESS AC MOTOR WITH EMBEDDED ELECTRONIC CONTROL

(71) Applicant: Ken WONG, Hong Kong (HK)

(72) Inventor: Ken WONG, Hong Kong (HK)

(21) Appl. No.: 15/417,240

(22) Filed: Jan. 27, 2017

(51) Int. Cl. H02P 6/16; H02P 6/182

(52) U.S. Cl. CPC H02P 6/16; H02P 6/182

(57) ABSTRACT

A control system for a 2-phase brushless AC motor comprises a position sensor for detecting a position of a rotor of the motor; a polarity detector for detecting a polarity of an AC supply for the motor; a first and second switching circuits respectively coupled to a first and second phase coils of the motor; a current sensor for detecting conduction of the first and second phase coils; and a controller for controlling conduction of the first and second switching circuits according to signals provided by the position sensor, the polarity detector and the current sensor; wherein the control system is embedded in the motor; and the controller is configured to turn on the first switching circuit at appropriate time interval in an AC cycle and turn on the second switching circuit to compensate for another time interval according to the position of the rotor.

### FIELD OF THE INVENTION

The present invention relates to brushless AC motors, and more particularly to a 2-phase brushless AC motor with embedded electronic control.

### BACKGROUND OF THE INVENTION

Existing AC powered motors on the market are either brushed or brushless type. Brushed motors are low efficiency and short service life. Brushless motor are used for applications where long service life and reliability is desired. PSC (phase split capacitor) motor is a brushless motor and is frequently adopted for simple to use and low cost. But PSC motor cannot control the rotation speed directly and the efficiency is usually less than 40%. The most advanced brushless motor in this category is electronic controlled brushless motor which is known for its variable speed control and high efficiency up to 80%. These are all high voltage DC powered known as BLDC (brushless DC) motor, inverter motor or electronic controlled induction motor. These electronic commutated motors include large heat sinks, multiple electrolytic DC smoothing capacitors and switching inductors for power conversion. The required DC power conversion components are expensive and bulky. None of these designs can put the whole electronic circuitry inside the motor case, except for those low wattage ones.

The new invention here is an alternative approach to implement a variable speed brushless motor with cost comparative to PSC motor, but performance as high as BLDC. It is a high efficient and compact motor with built in electronics.

### SUMMARY OF THE INVENTION

The object of the present invention is to provide a 2-phase brushless AC motor with embedded electronic control with cost comparative to PSC motor, but performance as high as BLDC.

The technical solutions of the present invention are as follows:

In a first aspect, the present invention provides a control system for a 2-phase brushless AC motor. The control system comprises a position sensor for detecting a position of a rotor of the motor, a polarity detector for detecting a polarity of an AC supply for the motor, a first and second switching circuits respectively coupled to a first and second phase coils of the motor, a current sensor for detecting conduction of the first and second phase coils, and a controller for controlling conduction of the first and second switching circuits according to signals provided by the position sensor, the polarity detector and the current sensor, wherein the control system is embedded in the motor; the position sensor, the polarity detector and the first and second switching circuits are connected to the controller; and the controller is configured to turn on the first switching circuit at appropriate time interval in an AC cycle and turn on the second switching circuit to compensate for another time interval according to the position of the rotor.

Advantageously, the control system further comprises a small AC/DC converter for converting the AC supply to DC supply.

Advantageously, the position sensor is either a Hall sensor or a back EMF detector; if using two Hall sensors then they are inserted between the first and second phase coils.

Advantageously, if the position sensor is by sensing coil back EMF, voltages across two ends of the coil are feed into a comparator, and a positive and negative input of the comparator is level shifted to 2.5V.

Advantageously, the polarity detector is a comparison circuit, the AC supply is inputted into a positive input of a comparator and a constant voltage, say 2.5V, is inputted into a negative input of the comparator.

Advantageously, the first and second switching circuits both comprise a triac.

Advantageously, an output signal of the triac is fed back to the controller for detecting the conduction of the first and second phase coils.

Advantageously, the first and second phase coils are both derived from a single AC supply; the controller is configured to conduct the first and second phase coils at opposite time cycles of the AC supply if a speed of the rotor is below a half of maximum speed so that if the first phase coil is conducted at a positive cycle of the AC supply, then the second phase coil is conducted at a negative cycle of the AC supply and vice versa; and the controller is further configured to conduct the first phase coil at the whole time cycle of the AC supply if the speed of the rotor approaches maximum speed.

Advantageously, the controller is configured to enable the second phase coil to conduct at an appropriate time cycle of the AC supply if the rotor rotates 90˜180 degree or 270˜360 degree.

Advantageously, a time lap between two consecutive trigger pulses fed back to the controller from the triac is introduced to control a speed of the motor, and the smaller the time lap is, the faster the speed of the motor is.

In a second aspect, the present invention provides a motor system comprises a 2-phase brushless AC motor and a control system as described in any one of the preceding paragraphs.

In a third aspect, the present invention provides a method for controlling a 2-phase brushless AC motor. The method comprises detecting a position of a rotor of the motor, detecting a polarity of an AC supply for the motor, detecting conduction of a first and second phase coils of the motor, and controlling conduction of the first and second phase coils according to signals of the position, polarity and conduction; wherein the first phase coil is switched on at appropriate time interval in an AC cycle and the second phase coil is either switched on to compensate for the time interval or remain at off state according to the position of the rotor.

Advantageously, the method further comprises conducting the first and second phase coils at opposite time cycles of the AC supply if a speed of the rotor is below a half of maximum speed so that if the first phase coil is conducted at a positive cycle of the AC supply, then conducting the second phase coil at a negative cycle of the AC supply and vice versa; and conducting the first phase coil at the whole time cycle of the AC supply if the speed of the rotor approaches maximum speed.

Advantageously, the method further comprises conducting the second phase coil at an appropriate time cycle of the AC supply if the rotor rotates 90˜180 degree or 270˜360 degree.

Advantageously, the method further comprises introducing a time lap between consecutive conduction signal of the first phase coil or the second phase coil to control a speed of the motor, and the smaller the time lap is, the faster the speed of the motor is.

The present invention is a direct AC drive motor. It avoids the AC/DC power conversion loss and the required components are just a few and that make it possible to embed inside the motor. It has similar pros as it BLDC counterpart. It embraces high efficiency, variable speed, brushless and long life. Moreover, it outperforms the BLDC by its low cost and small size. The present invention is by far the first electronic embedded brushless motor that is suitable for low power to high power application.

### BRIEF DESCRIPTION OF THE DRAWINGS

In order that the present invention may be more readily understood, embodiments of the invention will now be described, by way of example, with reference to accompanying drawings, in which:

FIG. 1 is a block diagram of a motor system in accordance with the present invention;

FIGS. 2a-2d show structures of 2-phase brushless AC motors with different poles;

FIGS. 3a-3c show conduction cycles of coil QA and coil QB;

FIG. 4a is a sectional view of the motor when coil QA conducts;

FIG. 4b shows a positive cycle when the coil QA of motor in FIG. 4a conducts;

FIG. 5a is a sectional view of the motor when coil QB conducts;

FIG. 5b shows a positive cycle when QB of the motor in FIG. 5a conducts;

FIG. 6a is a sectional view of the motor when QA conducts

FIG. 6b shows a negative cycle when QA of the motor in FIG. 6a conducts;

FIG. 7a is a sectional view of the motor when QB conducts;

FIG. 7b shows a negative cycle when QB of the motor in FIG. 7a conducts;

FIG. 8a is a sectional view of the motor when coil QA conducts;

FIG. 8b shows a positive cycle when the coil QA of motor in FIG. 4a conducts;

FIG. 9 is a circuit diagram of a polarity detector;

FIG. 10 is a circuit diagram of a position sensor according to one embodiment of the present invention;

FIG. 11 is a structural diagram of a position sensor according to another embodiment of the present invention;

FIG. 12 is a circuit diagram of a current sensor;

FIG. 13 shows a time lap between two consecutive trigger pulses Td;

FIG. 14 is a flow diagram of the method for controlling the 2-phase brushless AC motor.

### DETAILED DESCRIPTION OF THE EMBODIMENTS

The present invention will now be more particularly described, by way of example only, with reference to the accompanying drawings. It should be understood that the drawing are for better understanding and should not limit the present invention. Dimensions of components and features shown in the drawings are generally chosen for convenience and clarity of presentation and are not necessarily shown to scale.

Referring to the drawings, like numbers, if any, indicate like components throughout the view. As used in the description herein and throughout the claims that follow, the meaning of “a”, “an” and “the” includes plural reference unless the context dearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure.

As used herein, “around”, “about”, “approach” or “approximately” shall generally mean within 20 percent, preferably within 10 percent, and more preferably within 5 percent of a given value or range.

As used herein, “plurality” means two or more.

As used herein, the terms “comprising,” “including,” “carrying,” “having,” “containing,” “involving,” and the like are to understood to be open-ended, i.e., to mean including but not limited to.

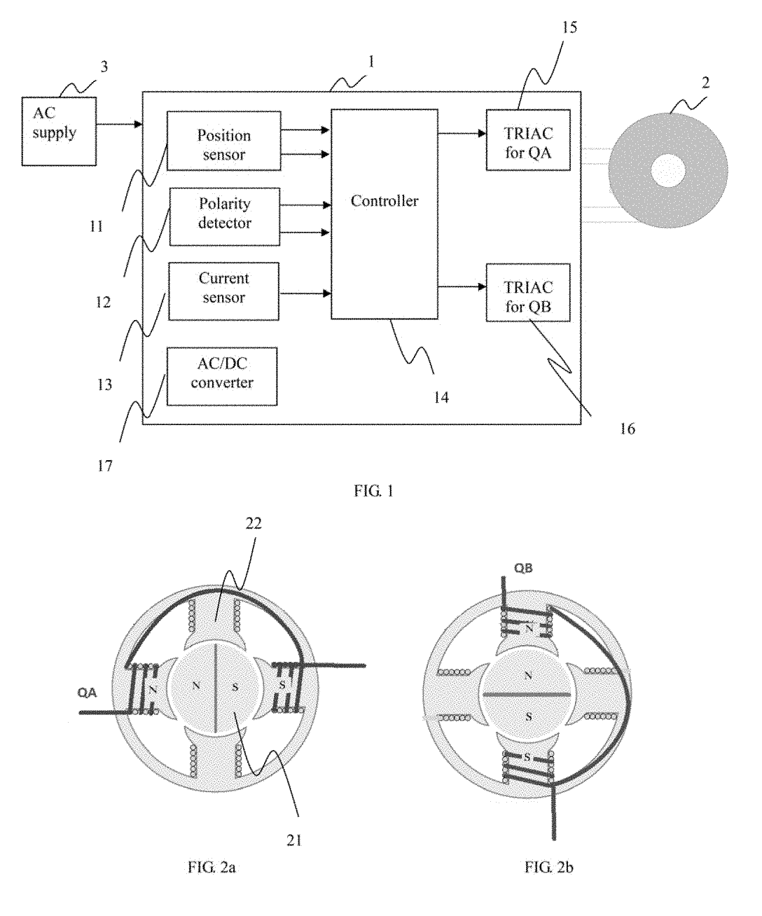

Referring to FIGS. 1-3, the motor system comprises a control system 1 and a 2-phrase brushless AC motor 2. Power to the motor system 1 is provided by an AC supply 3. The AC supply 3 is intended to be a domestic mains supply, though other power supplies capable of providing an alternating voltage might equally be used.

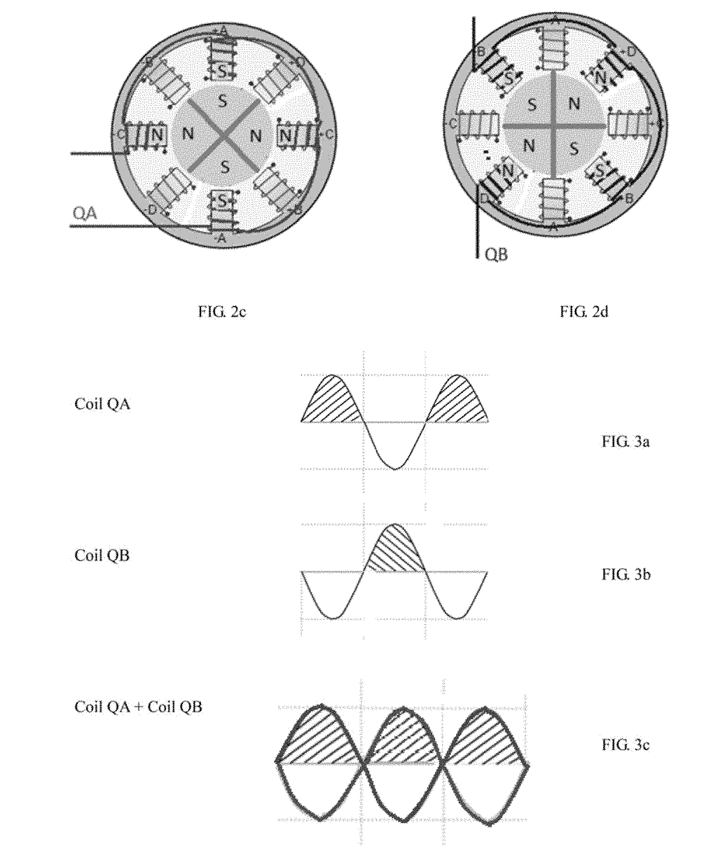

As shown in FIGS. 2a˜2d, the motor 2 may comprises a two pole or four pole rotor 21 that rotates relative to a stator 22. The stator 22 is an entirety that encloses the rotor 21. The number of slot in stator will double the number of pole in rotor. Conductive wires are wound about the stator 22 and are coupled to form two phase coils (windings) QA and QB. Understandably, the number of pole in rotor may also be six, eight or other suitable value.

The control system 1 comprises a position sensor 11 for detecting a position of the rotor 21 of the motor 2, a polarity detector 12 for detecting a polarity of the AC supply 3 for the motor 2, a current sensor 13 for detecting conduction of a first and second switching circuits 15 and 16, a controller 14, and the first and second switching circuits 15 and 16. As shown in FIG. 1, in one embodiment, the controller 14 can be an MCU, though other controller might equally be used. The two switching circuits 15 and 16 can be two TRIAC circuits, though other switching circuits capable of switching under AC input might be equally used. The control system 1 is embedded in the motor 2. The position sensor 11, the polarity detector 12, the current sensor 13 and the first and second switching circuits 15 and 16 are connected to the controller 14. The controller 14 is configured to turn on the first switching circuit 15 at appropriate time interval in an AC cycle and turn on the second switching circuit 16 to compensate for the time interval according to the position of the rotor 21.

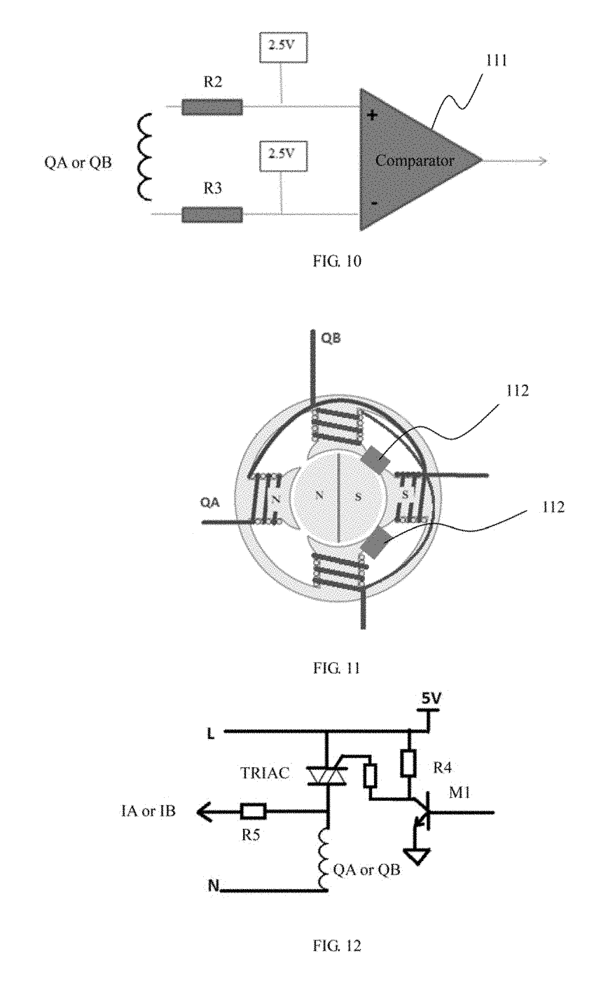

In one embodiment, as shown in FIG. 10, the position sensor 11 may be a comparison circuit for sensing a coil back EMF (electromotive force). Voltages across two ends of the coil QA or QB are fed into a comparator 111 via the resistors R2 and R3 respective, and a positive and negative input of the comparator is level shifted to 2.5V.

In another embodiment, as shown in FIG. 11, the position sensor 11 may also be a Hall sensor 112. Two Hall sensors are inserted between the first and second phase coils QA and QB.

The polarity detector 12 may also be a comparison circuits. As shown in FIG. 9, the AC supply is inputted into a positive input of a comparator via a resistor R1 and a constant voltage is directly inputted into a negative input of the comparator. The polarity detector 12 and the position sensor 11 may use a single comparator 111. For example, the operational amplifier LM 324 (Texas Instruments, Mexico) may be used as the comparator 111. The constant voltage may 2.5V for example, though other suitable value may be equally used according to the comparator.

The configurations of the first and second switching circuits 15 and 16 may be the same as each other, thus for the purpose of simplification, the present invention just provides one circuit for discussing the first and second switching circuits 15 and 16. As shown in FIG. 12, the first and second switching circuits 15 and 16 both comprise a TRIAC respectively. FIG. 12 shows the driver to trigger the TRIAC. To detect conduction of the first and second switching circuits 15 and 16 (i.e. the conduction of the coil QA and QB), a signal IA or IB is taken from terminal of TRIAC for QA or QB, and then fed back to the controller 14 via a resistor R5. When IA (or IB)=logic “0”, the TRIAC is off and therefore on current is passing through the coil QA (or QB). Otherwise, the coil QA (or QB) is conducted and current is passing therethrough. Accordingly, the circuit connecting the resistor R5 between the TRIAC and the controller works as the current sensor 13. Prior art uses 4 IGBT/MOSFETS connected in an H-bridge configuration. The input power is rectified, and the system is actually a U-Motor type incorporating PWM duty control. This is closer to the present invention, but the difference is that the present invention is much simpler. The present invention incorporates TRIAC control circuit that is commonly used on single phase synchronous motor. It manipulates the AC current input to two windings to make the speed variable. Due to the simplicity of present invention, it is easily expandable to high power applications and aimed as a low cost substitution for PSC motor.

In a preferred embodiment, the control system 1 may also comprises an AC/DC converter for converting the AC supply to DC supply. The DC supply may 5V, 3.3V or 1.8V, and other suitable value may be equally used according to the actual requirements.

Motor Operation

The operation of the motor system as it accelerates from stationary to running speed will now be described. To make it easy for manufacturing, the winding (coil) of this motor is similar to a typical BLDC motor or stepper motor. But their operation mechanisms are completely different. As the name suggested, two phase motor consists of two separate winding coils. Thus, the stator consists of 2-coils wound in 4n slot and 2n pole structure. A typical motor slot to pole ratio can be 4:2, 8:4, 16:8, etc. Since the motor is AC driven, the speed limitation is governed by the AC synchronized motor equation: RPM=120*f/p. That is a 2-pole rotor cannot exceed 3000 rpm using a 50 Hz street power (or 3600 rpm with 60 Hz street power). Similarly, a 4-pole rotor cannot exceed 1500 rpm (or 1800 rpm with 60 Hz street power). The electronic controller is analogy to the igniter of a car combustion engine. By sensing the position of rotor, the MCU fire the TRIAC to deliver sufficient current to the stator winding to generate electromechanical force to propel the rotor. The 2-phase design allows the motor to run smoothly. Imagine that the first phase winding propel the rotor to rotate 90 degree and followed by the second phase winding keeps the rotor to run for next 90 degree. The two phase design is necessary when the motor is running below its maximum speed.

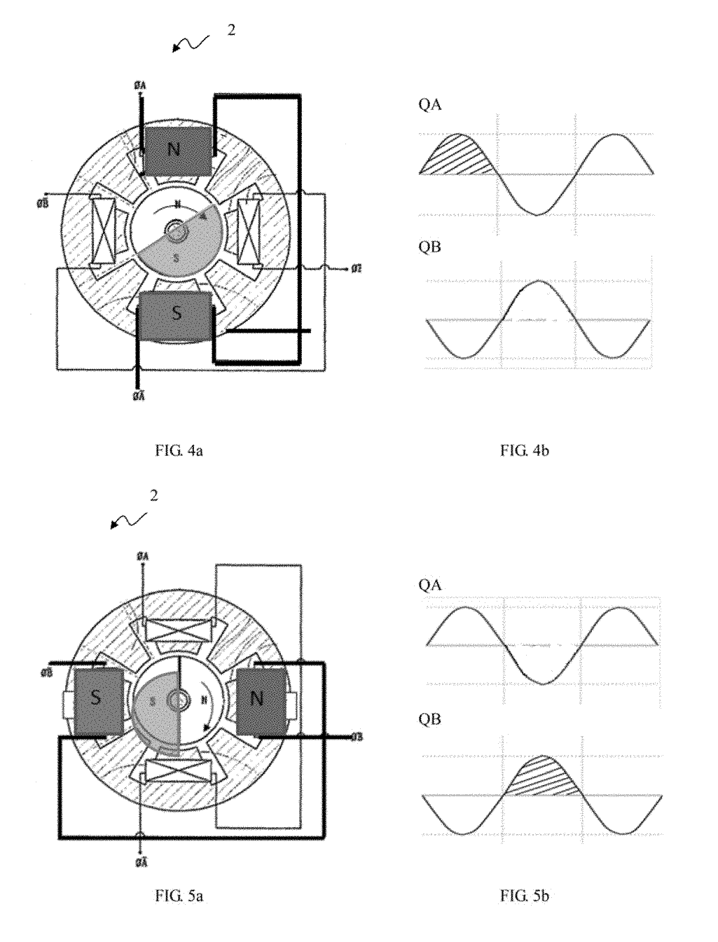

In the present invention, coil QA and coil QB must operate at different time cycle of the AC supply. Coil QA and QB are both derived from a single AC power source but they are 180 degree flipped. As shown in FIGS. 3a˜3c, it is designed that if coil QA work at positive cycle (shadow line) of the AC supply, then coil QB will be working at the negative cycle and vice versa. Alternatively if coil QA is working at full AC cycle, coil QB will not need to work at all. The key point is these two coils will not operate simultaneously. No matter at any time interval, either QA or QB will conduct current. This is necessary to make sure the rotor will always be powered even at all speed and no free run circumstance happens.

At speed above ½ of maximum speed, coil may conduct current at both positive and negative cycle of the supply voltage. Especially at maximum speed, the rotor will spin fast enough such that the auxiliary coil (the second coil) will not have a chance to conduct current. So in this scenario, only one of the coils will conduct current. This is like a single phase synchronous motor. The uncertainty is speed of motor between ½ max speed and maximum speed. In this region, we need to avoid overlapping of the coils current at the same time interval because essentially the coil generate opposite magnetic field. So if two coils are operating at the same time, energy will be wasted as the electromagnetic force canceled out each other and no usable mechanical torque will be produced. Details rules are exemplified below, each complete rotation takes 4 steps:

Step 1:

As shown in FIGS. 4a and 4b, rotation starts with coil QA conducting current during positive cycle of AC power. Now the rotor will be repelled and rotate in a defined direction. Understandably, the coil QA can also be designed to conduct current during negative cycle of the AC supply.

Step 2:

As shown in FIGS. 5a and 5b, depending on the position of the rotor, if the rotor rotates >90 degree, but <than 180 degree, and it fall into next negative cycle of power source, QB will conduct and keep the rotor running.

However, as shown in FIGS. 6a and 6b, if the rotor is fast enough (above a half of the maximum speed) and make it to 180 degree, coil QA will conduct at negative cycle of the AC supply. At that time, QB is bypassed. That is only coil QA is accounted for the rotation of the motor.

Step 3:

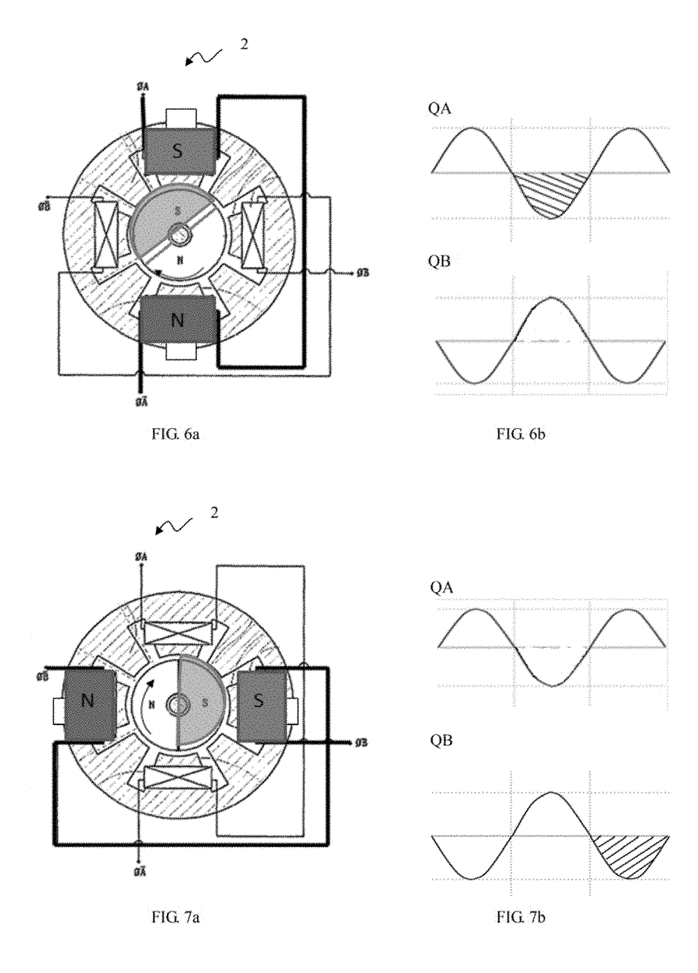

As shown in FIGS. 7a and 7b, if position of rotor is between 270 degree and 360 degree, coil QB will conduct at inverted negative cycle of the AC power.

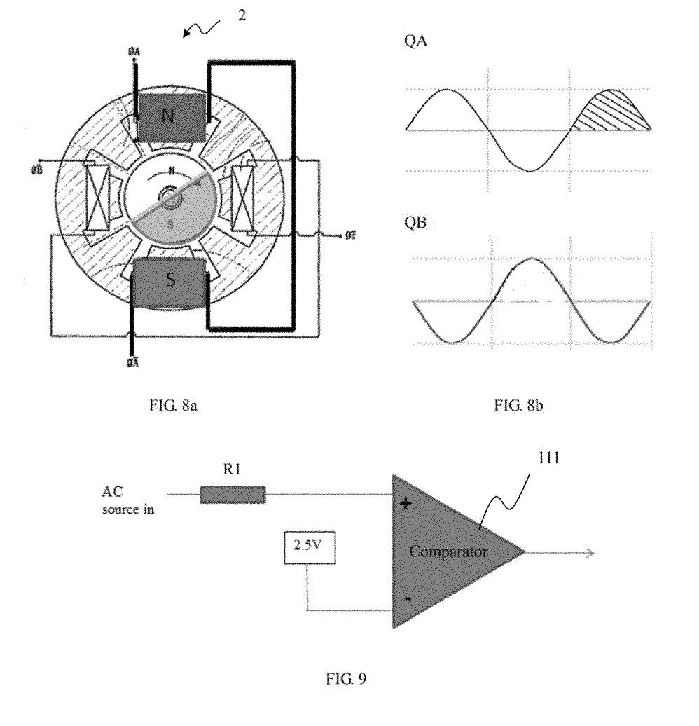

However, as shown in FIGS. 8a and 8b, if rotor is fast enough (above a half of the maximum speed) and make it to 360 degree, coil QA will conduct at positive cycle of AC power. Now this is back to step 1. At that time coil QB is bypassed. That is only QA is accounted for the rotation of motor.

Control Methods

The method for controlling the motor to run at different speed will now be described. As shown in FIG. 14, the method for controlling the 2-phase brushless AC motor comprises the following steps:

S102, detecting a position of a rotor of the motor;

S104, detecting a polarity of an AC supply for the motor;

S106, detecting conduction of a first and second phase coils of the motor; and

S108, controlling conduction of the first and second phase coils according to signals of the position, polarity and conduction; wherein the first phase coils is switched off for a time interval in an AC cycle and the second phase coil is switched on to compensate for the time interval according to the position of the rotor.

In one embodiment of the present invention, steps 102˜106 can be executed in parallel. However, in another embodiment of the present invention, steps 102˜106 can be executed in series.

In a preferred embodiment of the present invention, the method further comprises conducting the first and second phase coils at opposite time cycles of the AC supply if a speed of the rotor is below a half of maximum speed so that if the first phase coil is conducted at a positive cycle of the AC supply, then conducting the second phase coil at a negative cycle of the AC supply and vice versa; and conducting the first phase coil at the whole time cycle of the AC supply if the speed of the rotor is approaches maximum speed.

Specifically, the method further comprises conducting the second phase coil at an appropriate time cycle of the AC supply if the rotor rotates 90˜180 degree or 270˜360 degree.

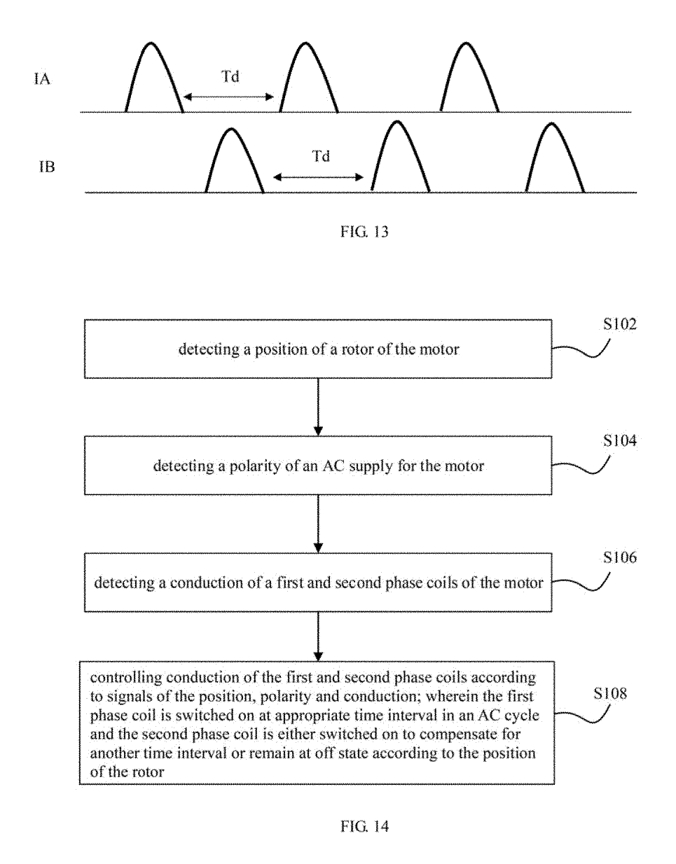

Specifically, as shown in FIG. 13, a time lap Td between two consecutive conduction signals of the first phase coil or the second phase coil is introduced to control a speed of the motor. Td is minimum no current time after the coil current returns to zero. The introduction of Td is for regulating the power deliver to the coil. In other words, if Td gets smaller, more power is given to the coil and it will run faster.

First the region where coil QA is conducting current is defined. The three conditions for coil QA to conduct current are:

1. (AC polarity) XOR (position sensor A)=1;

2. IB=0;

3. Outside Td (no current conducting) interval.

Similarly, three conditions applied for coil QB to conduct current are:

1. [NOT (AC polarity)] XOR (position sensor B)=1

2. IA=0;

3. Outside Td (no current conducting) interval.

Wherein, “AC polarity” means that it is in the right time cycle of the AC supply for coil QA or QB to conduct, and “position sensor” means that the rotation of the coil QA or QB is in appropriate range of degree as described in the preceding paragraphs.

With accurate control of the injection of AC current, the present invention is able to keep the rotor run at desired speed and direction. The present invention is a two-phase system. There are of course many two-phase motor design in the prior art. These include BLDC motors, CPU fan motor, PSC motors or synchronous motor. etc. But none of them is like the present invention. The key differences are:

1. Present invention is driven by an AC power source. There does not involve any H-bridge structure or PWM mechanism. So it is not the same as BLDC and its derivatives.

2. In two phase PSC motors or two phase synchronous motors, the secondary coil is for helping motor start. Whereas the present invention uses a secondary coil mainly for speed and direction control.

3. In present invention, the two coils of motor operate in separate time domain. The main advantage is the motor has no “dead zone” or start up difficulty as BDLC or PSC type motors.

I claim:

1. A control system for a 2-phase brushless AC motor, comprising:
a position sensor for detecting a position of a rotor of the motor;
a polarity detector for detecting a polarity of an AC supply for the motor;
a first and second switching circuits respectively coupled to a first and second phase coils of the motor;
a current sensor for detecting conduction of the first and second phase coils; and
a controller for controlling conduction of the first and second switching circuits according to signals provided by the position sensor, the polarity detector and the current sensor;
wherein the control system is embedded in the motor; the position sensor, the polarity detector, the current sensor and the first and second switching circuits are connected to the controller; and the controller is configured to turn on the first switching circuit at appropriate time interval in an AC cycle and turn on the second switching circuit to compensate for another time interval according to the position of the rotor.

2. The control system of claim 1, wherein the control system further comprises an AC/DC converter for converting the AC supply to DC supply.

3. The control system of claim 1, wherein the position sensor is a Hall sensor; and two Hall sensors are inserted between the first and second phase coils.

4. The control system of claim 1, wherein the position sensor is a back EMF detector for sensing a coil back EMF, voltages across two ends of the coil are fed into a comparator, and a positive and negative input of the comparator is level shifted to 2.5V.

5. The control system of claim 1, wherein the polarity detector is a comparison circuit, the AC supply is inputted into a positive input of a comparator and a constant voltage is inputted into a negative input of the comparator.

6. The control system of claim 1, wherein the first and second switching circuits both comprise a triac respectively.

7. The control system of claim 6, wherein an output signal of the triac is fed back to the controller for detecting the conduction of the first and second phase coils.

8. The control system of claim 1, wherein the first and second phase coils are both derived from a single AC supply; the controller is configured to conduct the first and second phase coils at opposite time cycles of the AC supply if a speed of the rotor is below a half of maximum speed so that if the first phase coil is conducted at a positive cycle of the AC supply, then the second phase coil is conducted at a negative cycle of the AC supply and vice versa; and the controller is further configured to conduct the first phase coil at the whole time cycle of the AC supply if the speed of the rotor approaches maximum speed.

9. The control system of claim 1, wherein the controller is configured to enable the second phase coil to conduct at an appropriate time cycle of the AC supply if the rotor rotates 90˜180 degree or 270˜360 degree.

10. The control system of claim 7, wherein a time lap between two consecutive trigger pulses fed back to the controller from the triac is introduced to control a speed of the motor, and the smaller the time lap is, the faster the speed of the motor is.

11. A motor system comprising a 2-phase brushless AC motor and the control system of claim 1.

12. A method for controlling a 2-phase brushless AC motor, comprising:
detecting a position of a rotor of the motor;
detecting a polarity of an AC supply for the motor;
detecting conduction of a first and second phase coils of the motor; and
controlling conduction of the first and second phase coils according to signals of the position, polarity and conduction; wherein the first phase coil is switched on at appropriate time interval in an AC cycle and the second phase coil is either switched on to compensate for another time interval or remain at off state according to the position of the rotor.

13. The method of claim 12, wherein the method further comprises conducting the first and second phase coils at opposite time cycles of the AC supply if a speed of the rotor is below a half of maximum speed so that if the first phase coil is conducted at a positive cycle of the AC supply, then conducting the second phase coil at a negative cycle of the AC supply and vice versa; and conducting the first phase coil at the whole time cycle of the AC supply if the speed of the rotor approaches maximum speed.

14. The method of claim 12, wherein the method further comprises conducting the second phase coil at an appropriate time cycle of the AC supply if the rotor rotates 90˜180 degree or 270˜360 degree.

15. The method of claim 12, wherein the method further comprises introducing a time lap between two consecutive conduction signals of the first phase coil or the second phase coil to control a speed of the motor, and the smaller the time lap is, the faster the speed of the motor is.
